(19) United States
(12) Patent Application Publication
(10) Pub. No.: US 2010/0240515 A1
(43) Pub. Date: Sep. 23, 2010

(54) LOW-SODIUM-OXIDE GLASS AND GLASS TUBE

(75) Inventor: Somchai Ovutthitham, Bangkok (TH)

Correspondence Address: BAKER & MCKENZIE LLP, 711 Louisiana, Suite 3400, HOUSTON, TX, 77002, US

(73) Assignee: L. LIGHTING GLASS COMPANY LIMITED, Chachoengsao (TH)

(21) Appl. No.: 12/692,219

(22) Filed: Jan. 22, 2010

Related U.S. Application Data
(63) Continuation-in-part of application No. 12/408,433, filed on Mar. 20, 2009.

(30) Foreign Application Priority Data
Sep. 29, 2009 (TH) 0901004409

(51) Int. Cl. C03C 3/087

(52) U.S. Cl. 501/70

(57) ABSTRACT

The low-sodium-oxide glass and glass tube, which have the following chemical components 55.0-70.0% SiO₂, 2.0-4.0% Al₂O₃, 3.0-7.0% MgO, and CaO, 0-3.5% SrO, 10.5-13.0% BaO, 2.0-4.0% Li₂O, <1.0% Na₂O, 11.0-14.0% K₂O, 0.1-0.6% CeO₂, (0.02%) TiO₂, and (0.03%) Fe₂O₃, has been disclosed to replace the borosilicate glass, with improvements to the physical properties and chemical durability, transmittance percentage controlled in the wave length interval at 313 nanometers (nm.), including the dielectric constant at the temperature of 25° C., 1 MHz and the dielectric loss, tan δ, or the dissipation factor at the temperature of 25° C., 1 MHz, for maximum effectiveness for the light bulb manufacturing industry and also for other industries, for instance, backlights tubes, fluorescent lamps, circular fluorescent lamps, compact fluorescent lamps, stems (flare tubes), and exhaust tubes.

### PRIOR RELATED APPLICATIONS

This application is a Continuation-in-Part of application Ser. No. 12/408,433, filed Mar. 20, 2009, and claims priority to Thailand Patent Application Serial No. 0901004409, filed on Sep. 29, 2009, which both are incorporated herein in their entirety.

### FEDERALLY SPONSORED RESEARCH STATEMENT

Not applicable.

### REFERENCE TO MICROFICHE APPENDIX

Not applicable.

### FIELD OF INVENTION

This invention falls within a branch of chemistry relating to the manufacture of glass and glass tubes with low sodium oxide.

### BACKGROUND OF THE INVENTION

Technology and innovation on the manufacture of electrical appliances, equipment used for connection to computers, such as, flat-screen TVs, LCD, scanners, navigation systems, all involve designs and developments into modern looks, taking into consideration convenience of users, who will be able to carry them to everywhere, and ease of move. Therefore, developments must be made with respect to appropriate size and weight. Glass tubes for the manufacture of backlights require the use of small-diameter glass. At present, there are manufacturers of glass tubes for the manufacture of backlights to accommodate the market of these electrical appliances, and they tend to expand themselves quickly.

Low-sodium-oxide glass tubes for the manufacture of light bulbs replace glass tubes for the manufacture of backlights, which are generally made of borosilicate glass with approx. 10-20 percent boric oxide. This makes it difficult for glass to melt and the cost of production is high. In addition, there is an important factor regarding the fairly low coefficient of expansion, a, of borosilicate glass when heated. As a result, when it is used by the light bulb manufacturing industry, it must select a metal wire for sealing with the coefficient of expansion, α, close to the fairly low coefficient of expansion, α, of borosilicate glass. Those currently used are tungsten, molybdenum and kovar wires, which are at somewhat high prices. Therefore, in the invention of low-sodium-oxide glass tubes for the manufacture of light bulbs, the coefficient of expansion, α, of the glass when heated has been adjusted and developed to a value close to that of a dumet wire, which is of lower cost. As a result, light bulb manufacturing business operators also incur lower cost. And through the preparation of chemical components of low-sodium-oxide glass tubes for the manufacture of light bulbs having regard to the glass softening point (Ts), which is lower than that of the borosilicate glass, and the working temperature (Tw), which is higher than that of the borosilicate glass, the working range becomes wider than that of the borosilicate glass by at least 450° C., which is one of the very important properties.

The invention of low-sodium-oxide glass tubes for the manufacture of light bulbs adds the improvement of the glass quality for the absorbance of light waves in the range of ultraviolet rays (UV). It is known that the UV light wave is dangerous, and in the invention the wave length at 313 nanometers (nm.) will be controlled through the application of cerium oxide (CeO₂).

The significant advantage of low-sodium-oxide glass tubes for the manufacture of light bulbs is the glass tube durability with chemical resistance and better dielectric constant. There has been a development of the ratio of soda ash, which yields the value of sodium oxide (Na₂O); and potassium carbonate, which yields the value of potassium oxide (K₂O); barium carbonate, which yields the value of barium oxide (BaO), and other chemical components that have environmental awareness without hazardous heavy metals, such as, lead (Pb), arsenic (As), cadmium (Cd), mercury (Hg), hexavalent chromium (CrVI), polybrominated biphenyl (PBB), polybrominated diphenyl ether (PBDE), etc. in accordance with the directive or rules and regulations on restricted chemical substances, such as RoHS or REACH.

### BRIEF SUMMARY OF THE INVENTION

An invention concerning low-sodium-oxide glass and glass tubes to replace borosilicate glass results in lower cost of production and emphasizes on an adjustment to quality for the absorbance of light in the range of ultraviolet rays (UV). The wave length will be measured at 313 nanometers (nm.). This invention comprises an adjustment to the durability of glass and glass tubes so that they have better chemical resistance and dielectric constant and physical properties through the selection of chemical components which are not hazardous to the environment. This is also a technique suitable to glass and glass tubes for the light bulb manufacturing industry and for other industries, for instance, fluorescent lamps and circular fluorescent lamps, compact fluorescent lamps, stems (flare tubes), exhaust tubes, and backlights tubes.

### DETAILED DESCRIPTION OF EMBODIMENTS OF THE INVENTION

This invention results from the outcome of a study aiming at the finding of glass tubes with low-sodium-oxide for the manufacture of backlights to replace borosilicate glass so that the cost of production becomes lower and that adjustments and improvements are made to the quality for the absorbance of ultraviolet rays (UV). It is known that this UV light wave is harmful to components assembled in flat screen televisions, LCD-TFT television screens, flat screen PCs and laptops, scanners and navigation systems. According to the result of these studies in conjunction with the background as a manufacturer of both soda-lime glass and lead-free glass tubes for light bulbs, the inventor has discovered that it could adjust and improve the property regarding the transmittance of ultraviolet rays (UV) for the absorbance of the light wave controlled in the range of a 313 nanometer (nm.) wavelength by admixing a 0.1-0.6% quantity of cerium oxide (CeO₂), causing the light transmittance value to be less than 2.0%. In addition, the value of glass durability must be taken into consideration with a development of soda ash, which yields the value of sodium oxide (Na₂O) less than 1.0%, thereby resulting in good chemical resistance; and lithium carbonate (Li₂CO₃), which yields the value of lithium oxide (Li₂O)=2-4%; strontium carbonate, which yields the value of strontium oxide (SrO)=0-3.5%; magnesium carbonate, which yields the value of magnesium oxide (MgO); and calcium carbonate, which yields the value of calcium oxide (CaO)=3-7%.

In the invention, the dielectric constant has been improved by applying potassium carbonate, which yields the value of potassium oxide (K₂O)=11-14%; barium carbonate, which yields the value of barium oxide (BaO)=10.5-13%. As a result, the dielectric constant at 25° C., 1 MHz increases to approximately 7.5. The dielectric constant of borosilicate glass at the temperature of 25° C., 1 MHz is approximately 5-6. Moreover, the invention of low-sodium oxide glass and glass tube incurs low dielectric loss, tan δ, or dissipation factor at the temperature of 25° C., 1 MHz at approximately 0002, which is fairly favorable to the glass tubes for the external electrode fluorescent lamps (EEFLs) manufacturing industry as it will prolong their useful life. This is because when the dielectric glass sustains the electric voltage at a value exceeding its ability to withstand such electric voltage or electric field, the electricity will rush through the dielectric glass to the extent that eventually causes the dielectric breakdown, thereby creating free charge and consequently turning it into a conductor. In the course of invention, the inventor also studied the electric volume resistivity, log ρ, (Ω. cm). The electric volume resistivity of low-sodium oxide glass and glass tubes at the temperature of 150° C. is approximately 13.3-13.5.

The invention of low-sodium-oxide glass tubes for the manufacture of light bulbs has improved and developed the coefficient of expansion, a, of glass when heated so that it is close to that of dumet wires, which are of lower cost. The alpha value (α) yielded will be around (92.0-99.0)×10⁻⁷/° C. And through the preparation of chemical components of low sodium oxide for the manufacture of backlights, having regard to the value of glass flexibility or softening (softening point), which is lower than that of borosilicate glass, i.e. the borosilicate glass softening point is >700° C. and the softening point of this low-sodium-oxide glass invented is =670-700° C. and its working point, Tw, is higher than that of the borosilicate glass, its working range becomes wider than that of the borosilicate glass by at least 450° C., which range is beneficial to the light bulb manufacturing industry.

This invention contains a general description. It will be better understood by reference to special examples included herein only for the purpose of indication, and they are not considered limitations of the invention unless otherwise explained.

The invention of low-sodium-oxide glass and glass tubes comprise chemical components as follows: 55.0-70.0% SiO₂, 2.0-4.0% Al₂O₃, 3.0-7.0% MgO and CaO, 0-3.5% SrO, 10.5-13.0% BaO, 2.0-4.0% Li₂O, <1.0% Na₂O, 11.0-14.0% K₂O, 0.1-0.6% CeO₂, (0.03%) Fe₂O₃.

### Example 1

Prepare chemical components to calculate the quantity of raw materials to be mixed together. The raw materials are represented by percentage weight as follows:

| Components | Percent |
|---|---|
| SiO₂ | 61.85 |
| Al₂O₃ | 3.00 |
| MgO/CaO | 5.00 |
| SrO | 3.00 |
| BaO | 11.00 |
| Li₂O | 2.50 |
| Na₂O | 0.15 |
| K₂O | 13.0 |
| CeO₂ | 0.50 |

The chemical components above will be applied to the calculation of the proportion of raw materials required to be mixed and melted into glass at the temperature of 1450° C. in a lab furnace. When a specimen has been obtained, steps are then taken to examine its physical properties. The result obtained is as follows:

| Physical Properties | Results Obtained |
|---|---|
| Alpha (30-380° C. × 10⁻⁷/° C.) | 92.3 |
| Density (g/cc) | 2.687 |
| Glass transition, Tg (° C.) | 523 |
| Annealing point, Ta (° C.) | 587 |
| Softening point, Ts (° C.) | 699 |
| Working point, Tw (° C.) | 1176 |

From the result obtained, the working range will be 477° C.

Examine the chemical durability by the method under JIS R3502 (Na₂O mg), with the use of an autoclave at 121° C. for a period of 60 minutes. The concentration (R₂O mg/l) is as follows:

| | |
|---|---|
| Na₂O | <0.5 |
| K₂O | 10.1 |
| Li₂O | 2.7 |

### Example 2

Prepare chemical components to calculate the quantity of raw materials to be mixed together. The raw materials are represented by percentage weights as follows:

| Components | Percent |
|---|---|
| SiO₂ | 61.35 |
| Al₂O₃ | 3.00 |
| MgO/CaO | 5.00 |
| SrO | 3.00 |
| Bao | 11.00 |
| Li₂O | 3.00 |
| Na₂O | 0.15 |
| K₂O | 13.00 |
| CeO₂ | 0.50 |

The chemical components above will be applied to the calculation of the proportion of raw materials required to be mixed and melted into glass at the temperature of 1450° C. in a lab furnace. When a specimen has been obtained, steps are then taken to examine its physical properties. The results obtained are as follows:

| | Results |
|---|---|
| Physical Properties | Obtained |
| Alpha (30-380° C. × 10⁻⁷/° C.) | 95.6 |
| Density (g/cc) | 2.703 |
| Glass transition, Tg (° C.) | 511 |
| Annealing point, Ta (° C.) | 559 |
| Softening point, Ts (° C.) | 685 |
| Working point, Tw (° C.) | 1150 |
| From the result obtained, the working | |
| range will be 465° C. | |
| Volume resistivity log ρ (Ω · cm) (150° C.) | 13.5 |
| Dielectric constant at 25° C., 1 MHz | 7.34 |
| Dissipation factor at 25° C., 1 MHz | 0.0018 |

Examine the chemical durability by the method under JIS R3502 (Na2O mg) using an autoclave at 121° C. for a period of 60 minutes. The concentration, R2O mg/l, is as follows:

| | |
|---|---|
| Na₂O | <0.5 |
| K₂O | 10.1 |
| Li₂O | 2.8 |

### Example 3

Prepare chemical components to calculate the quantity of raw materials to be mixed together. The raw materials are represented by percentage weight as follows:

| Components | Percent |
|---|---|
| SiO₂ | 62.52 |
| Al₂O₃ | 3.00 |
| MgO | 2.04 |
| CaO | 2.96 |
| SrO | 3.00 |
| BaO | 11.00 |
| Li₂O | 3.00 |
| Na₂O | 0.15 |
| K₂O | 12.00 |
| CeO₂ | 0.30 |
| TiO₂ | 0.013 |
| Fe₂O₃ | 0.015 |

The chemical components above will be applied to the calculation of the proportion of raw materials required to be mixed and melted into glass at the temperature of 1450° C. in a lab furnace. When a specimen has been obtained, steps are then taken to examine its physical properties. The result obtained is as follows:

| Physical Properties | Results Obtained |
|---|---|
| Alpha (30-380° C. × 10⁻⁷/° C.) | 96.6 |
| Density (g/cc) | 2.67 |
| Softening point, Ts (° C.) | 689 |
| Volume resistivity log ρ (Ω · cm) (150° C.) | 13.3 |
| Dielectric constant at 25° C., 1 MHz | 7.36 |
| Dissipation factor at 25° C., 1 MHz | 0.0023 |

### Example 4

Prepare chemical components to calculate the quantity of raw materials to be mixed together. The raw materials are represented by percentage weights as follows:

| Components | Percent |
|---|---|
| SiO₂ | 61.52 |
| Al₂O₃ | 3.00 |
| MgO | 1.64 |
| CaO | 4.36 |
| SrO | 3.00 |
| BaO | 11.00 |
| Li₂O | 3.00 |
| Na₂O | 0.15 |
| K₂O | 12.00 |
| CeO₂ | 0.30 |
| TiO₂ | 0.012 |
| Fe₂O₃ | 0.015 |

The chemical components above will be applied to the calculation of the proportion of raw materials required to be mixed and melted into glass at the temperature of 1450° C. in a lab furnace. When a specimen has been obtained, steps are then taken to examine its physical properties. The results obtained are as follows:

| Physical Properties | Results Obtained |
|---|---|
| Alpha (30-380° C. × 10⁻⁷/° C.) | 99.0 |
| Softening point, Ts (° C.) | 686 |
| Volume resistivity log ρ (Ω · cm) (150° C.) | 13.4 |
| Dielectric constant at 25° C., 1 MHz | 7.48 |
| Dissipation factor at 25° C., 1 MHz | 0.0021 |

### Example 5

Prepare chemical components to calculate the quantity of raw materials to be mixed together. The raw materials are represented by percentage weight as follows:

| Components | Percent |
|---|---|
| SiO₂ | 61.52 |
| Al₂O₃ | 3.00 |
| MgO | 1.65 |
| CaO | 5.35 |
| BaO | 13.00 |
| Li₂O | 3.00 |
| Na₂O | 0.15 |
| K₂O | 12.00 |
| CeO₂ | 0.30 |
| TiO₂ | 0.012 |
| Fe₂O₃ | 0.015 |

The chemical components above will be applied to the calculation of the proportion of raw materials required to be mixed and melted into glass at the temperature of 1450° C. in a lab furnace. When a specimen has been obtained, steps are then taken to examine its physical properties. The result obtained is as follows:

| Physical Properties | Results Obtained |
|---|---|
| Alpha (30-380° C. × 10⁻⁷/° C.) | 97.5 |
| Softening point, Ts (° C.) | 688 |
| Volume resistivity log ρ (Ω · cm) (150° C.) | 13.4 |
| Dielectric constant at 25° C., 1 MHz | 7.49 |
| Dissipation factor at 25° C., 1 MHz | 0.0022 |

### Example 6

Prepare chemical components to calculate the quantity of raw materials to be mixed together. The raw materials are represented by percentage weights as follows:

| Components | Percent |
|---|---|
| SiO₂ | 61.50 |
| Al₂O₃ | 3.00 |
| MgO | 1.63 |
| CaO | 5.37 |
| BaO | 13.00 |
| Li₂O | 3.00 |
| Na₂O | 0.59 |
| K₂O | 11.56 |
| CeO₂ | 0.30 |
| TiO₂ | 0.019 |
| Fe₂O₃ | 0.027 |

The chemical components above will be applied to the calculation of the proportion of raw materials required to be mixed and melted into glass at the temperature of 1450° C. in a lab furnace. When a specimen has been obtained, steps are then taken to examine its physical properties. The results obtained are as follows:

| Physical Properties | Results Obtained |
|---|---|
| Alpha (30-380° C. × 10⁻⁷/° C.) | 98.0 |
| Density (g/cc) | 2.6824 |
| Softening point, Ts (° C.) | 676 |
| Volume resistivity log ρ (Ω · cm) (150° C.) | 13.5 |
| Dielectric constant at 25° C., 1 MHz | 7.46 |
| Dissipation factor at 25° C., 1 MHz | 0.0020 |

### Example 7

Prepare chemical components to calculate the quantity of raw materials to be mixed together. The raw materials are represented by percentage weights as follows:

| Components | Percent |
|---|---|
| SiO₂ | 63.70 |
| Al₂O₃ | 3.00 |
| MgO | 2.04 |
| CaO | 2.96 |
| BaO | 12.00 |
| Li₂O | 3.00 |
| Na₂O | 1.00 |
| K₂O | 12.00 |
| CeO₂ | 0.30 |

The chemical components above will be applied to the calculation of the proportion of raw materials required to be mixed and melted into glass at the temperature of 1450° C. in a lab furnace. When a specimen has been obtained, steps are then taken to examine its physical properties. The results obtained are as follows:

| Physical Properties | Results Obtained |
|---|---|
| Alpha (30-380° C. × 10⁻⁷/° C.) | 97.6 |
| Density (g/cc) | 2.63 |
| Softening point, Ts (° C.) | 675 |

### Example 8

Prepare chemical components to calculate the quantity of raw materials to be mixed together. The raw materials are represented by percentage weights as follows:

| Components | Percent |
|---|---|
| SiO₂ | 64.20 |
| Al₂O₃ | 3.00 |
| MgO | 2.04 |
| CaO | 2.96 |
| BaO | 12.00 |
| Li₂O | 2.50 |
| Na₂O | 1.00 |
| K₂O | 12.00 |
| CeO₂ | 0.30 |

The chemical components above will be applied to the calculation of the proportion of raw materials required to be mixed and melted into glass at the temperature of 1450° C. in a lab furnace. When a specimen has been obtained, steps are then taken to examine its physical properties. The results obtained are as follows:

| Physical Properties | Results Obtained |
|---|---|
| Alpha (30-380° C. × 10⁻⁷/° C.) | 95.9 |
| Density (g/cc) | 2.63 |
| Softening point, Ts (° C.) | 688 |

### Example 9

Prepare chemical components to calculate the quantity of raw materials to be mixed together. The raw materials are represented by percentage weights as follows:

| Components | Percent |
|---|---|
| SiO₂ | 63.35 |
| Al₂O₃ | 3.00 |
| MgO | 2.04 |
| CaO | 2.96 |
| SrO | 2.00 |
| BaO | 11.00 |
| Li₂O | 3.00 |
| Na₂O | 0.35 |
| K₂O | 12.00 |
| CeO₂ | 0.30 |

The chemical components above will be applied to the calculation of the proportion of raw materials required to be mixed and melted into glass at the temperature of 1450° C. in a lab furnace. When a specimen has been obtained, steps are then taken to examine its physical properties. The results obtained are as follows:

| Physical Properties | Results Obtained |
|---|---|
| Alpha (30-380° C. × 10⁻⁷/° C.) | 96.5 |
| Density (g/cc) | 2.65 |
| Softening point, Ts (° C.) | 683 |

From the above-mentioned example, it was found that the chemical durability yielded the concentration of Na₂O<1.0 mg/l.

Bring the low-oxide-glass and glass tube from this invention with the approximate thickness of 1.0 mm. to test the percentage of transmittance of ultraviolet rays (UV) so that it the light wave absorbance is controlled in the wave length interval of 313 nanometers (nm.). It was found that the transmittance value <2.0%.

We claim:

1-7. (canceled)

8. A low-sodium-oxide glass comprising the following chemical components by percentage weight as follows silicon dioxide (SiO₂) from about 55.0 to about 70.0; aluminum oxide (Al₂O₃) from about 2.0 to about 4.0; barium oxide from about 10.5 to about 13.0; a mixture of magnesium oxide (Mg) and calcium oxide (CaO) from about 3.0 to about 7.0; sodium oxide (Na₂O) less than about 1.0; potassium oxide (K₂O) from about 11.0 to about 14.0; lithium oxide (Li₂O) from about 2.0 to about 4.0; cerium oxide (CeO₂) from about 0.1 to about 0.6; strontium oxide (SrO) from about 0 to about 3.5; titanium dioxide (TiO₂) about 0.02; and iron oxide (Fe₂O₃) about 0.03.

9. The low-sodium-oxide glass of claim 8 having a softening point ranging from about 670 to about 700° C., and a working point (Tw) greater than that of borosilicate glass.

10. The low-sodium-oxide glass of claim 9 having a working range of at least about 450° C.

11. The low-sodium-oxide glass of claim 8 having a concentration of Na₂O less than about 1.0 mg/l.

12. The low-sodium-oxide glass of claim 8, having has a dielectric constant at the temperature of 25° C., 1 MHz at the approximate value of about 7.5 and a low dielectric loss, tan δ, or dissipation factor at the temperature of 25° C., 1 MHz at the approximate value of about 0.002.

13. The low-sodium-oxide glass of claim 8, suitable for the manufacture of glass and glass tubes for manufacturing light bulbs and other products, such as fluorescent lamps, and circular fluorescent lamps, compact fluorescent lamps, stems (flare tubes), and exhaust tubes.

14. A low-sodium-oxide glass tube in the manufacture of backlights comprising the low sodium oxide glass of claim 8.

15. The low-sodium-oxide glass tube of claim 14, wherein the thickness does not exceed about 1.0 millimeter (mm), having a percentage of transmittance of ultraviolet rays is less than about 2.0% controlled in the wave length interval at about 313 nanometers (nm.).

16. A low-sodium-oxide glass tube replacing borosilicate glass tubes in the manufacture of backlights comprising the low sodium oxide glass of claim 8.
